(19) United States
(12) Patent Application Publication
(10) Pub. No.: US 2026/0301987 A1
(43) Pub. Date: Oct. 1, 2026

(54) COMPOSITE OPTICAL BENCH

(71) Applicant: Quantinuum LLC, Broomfield, CO (US)

(72) Inventors: Adam Jay OLLANIK, Boulder, CO (US); Rezlind BUSHATI, Rockville, MD (US); David MILLER, Broomfield, CO (US); David M. GAUDIOSI, Loveland, CO (US); Timothy James COSENTINO, Waitsfield, VT (US)

(21) Appl. No.: 19/576,458

(22) Filed: Mar. 24, 2026

Related U.S. Application Data
(60) Provisional application No. 63/781,669, filed on Apr. 1, 2025.

(51) Int. Cl. G21K 1/20

(52) U.S. Cl. CPC G21K 1/20

(57) ABSTRACT

Example embodiments provide methods, systems, apparatuses, computer program products and/or the like for composite optical benches. A composite optical bench may comprise: one or more beam array sources hosted by a first housing; one or more beam-specific optics hosted by one or more second housings; and one or more optional global optics hosted by one or more third housings, wherein the first housing, the one or more second housings, and the one or more third housings are aligned using: an axial alignment configuration defining axial separation of elements hosted by the first housing, the one or more second housings, and the one or more third housings; and a radial alignment configuration wherein the one or more second housings and the one or more third housings are positioned after the first housing, and wherein the one or more second housings and the one or more third housings are variously positioned.

### CROSS-REFERENCE TO RELATED APPLICATION(S)

This application claims priority to U.S. Application No. 63/781,669, filed Apr. 1, 2025, the content of which is incorporated herein by reference in its entirety.

### TECHNICAL FIELD

Various embodiments relate to apparatuses, systems, and methods for composite optical bench assemblies.

### BACKGROUND

Optical benches comprised of a plurality of separately manufactured components may, in some examples, rely on high accuracy mounting. For example, adjustable mounting and/or active control may be used to couple the plurality of separately manufactured components. Such optical benches having separately manufactured components may present challenges in usability, reliability, stability, and/or other factors. Through applied effort, ingenuity, and innovation, many deficiencies of prior optical benches, for example, such as optical benches comprised of a plurality of separately manufactured components, have been solved by developing solutions that are structured in accordance with the embodiments of the present invention, many examples of which are described in detail herein.

### BRIEF SUMMARY OF EXAMPLE EMBODIMENTS

Example embodiments provide apparatuses, systems, methods, computer program products, and/or the like for composite optical benches. In various embodiments, composite (e.g., permanent) packaging of components of the composite optical benches may decrease overall footprint of the optical benches and/or simply use thereof.

According to an aspect of the present disclosure, there is provided an apparatus comprising: (i) one or more beam array sources hosted by a first housing; (ii) one or more beam-specific optics hosted by one or more second housings; and (iii) one or more optional global optics hosted by one or more third housings, wherein the first housing, the one or more second housings, and the one or more third housings are aligned using: (1) an axial alignment configuration defining axial separation of elements hosted by the first housing, the one or more second housings, and the one or more third housings; and (2) a radial alignment configuration of optical components including the one or more beam array sources, the one or more beam-specific optics, and the one or more optional global optics, and wherein the one or more second housings and the one or more third housings are positioned after the first housing, and wherein the one or more second housings and the one or more third housings are variously positioned.

In some embodiments, the one or more second housings are positioned before the one or more third housings; the one or more third housings are positioned before the one or more second housings; or the one or more second housings and the one or more third housings are interspersed among one another.

In some embodiments, the apparatus further comprises one or more target arrays configured to collect at least some beams passing through at least one component of the apparatus.

In some embodiments, the one or more beam array sources are at least one of: one or more photonic integrated circuits (PICs); or one or more fiber arrays.

In some embodiments, the one or more beam-specific optics are at least one of: one or more metasurfaces; one or more diffractive optical elements (DOEs); one or more microlens arrays; one or more wire-grid polarizers; or one or more mode converters.

In some embodiments, the one or more global optics are at least one of: one or more conventional refractive optics; one or more conventional waveplates; or one or more conventional polarizers.

In some embodiments, the axial alignment configuration is achieved by physical geometry of the elements or manufactured housings.

In some embodiments, the radial alignment configuration is achieved by active optical alignment or aligned die bonding of the elements.

In some embodiments, the axial alignment defines pitch or yaw of the elements.

In some embodiments, the radial alignment defines roll of the elements.

According to an aspect of the present disclosure, there is provided a method comprising: (i) configuring one or more beam array sources on a first housing; (ii) fabricating one or more beam-specific optics on one or more second housings; (iii) fabricating one or more optional global optics on one or more third housings; (iv) positioning the one or more second housings and the one or more third housings after the first housing; and (v) aligning the first housing, the one or more second housings, and the one or more third housings using: (1) an axial alignment configuration defining axial separation of elements hosted by the first housing, the one or more second housings, and the one or more third housings; and (2) a radial alignment configuration of optical components including the one or more beam array sources, the one or more beam-specific optics, and the one or more optional global optics.

In some embodiments, the method further comprises variously positioning the one or more second housings and the one or more third housings such that: the one or more second housings are positioned before the one or more third housings; the one or more third housings are positioned before the one or more second housings; or the one or more second housings and the one or more third housings are interspersed among one another.

In some embodiments, the method further comprises: configuring one or more target arrays on a fourth housing, the one or more target arrays configured to collect at least some beams passing through at least one component of the first, second, or third housings; and positioning the fourth housing after the variously positioned one or more second housings and one or more third housings such that the first housing and the fourth housing surround the one or more second housings and the one or more third housings.

In some embodiments, the one or more beam array sources are at least one of: one or more photonic integrated circuits (PICs); or one or more fiber arrays.

In some embodiments, the one or more beam-specific optics are at least one of: one or more metasurfaces; one or more diffractive optical elements (DOEs); one or more microlens arrays; one or more wire-grid polarizers; or one or more mode converters.

In some embodiments, the one or more global optics are at least one of: one or more conventional refractive optics; one or more conventional waveplates; or one or more conventional polarizers.

In some embodiments, the axial alignment configuration is achieved by physical geometry of the elements or manufactured housings.

In some embodiments, the radial alignment configuration is achieved by active optical alignment or aligned die bonding of the elements.

In some embodiments, the axial alignment defines pitch or yaw of the elements.

In some embodiments, the radial alignment defines roll of the elements.

According to an aspect of the present disclosure, there is provided a system comprising: (i) an atomic particle confinement apparatus; and (ii) a composite optical bench assembly comprising: (1) one or more beam array sources hosted by a first housing; (2) one or more beam-specific optics hosted by one or more second housings; and (3) one or more global optics hosted by one or more third housings, wherein the first housing, the one or more second housings, and the one or more third housings are aligned using: (a) an axial alignment configuration defining axial separation of elements hosted by the first housing, the one or more second housings, and the one or more third housings; and (b) a radial alignment configuration of optical components including the one or more beam array sources, the one or more beam-specific optics, and the one or more optional global optics, wherein the one or more second housings and the one or more third housings are positioned after the first housing, and wherein the one or more second housings and the one or more third housings are variously positioned.

In some embodiments, the one or more second housings are positioned before the one or more third housings; the one or more third housings are positioned before the one or more second housings; or the one or more second housings and the one or more third housings are interspersed among one another.

In some embodiments, the system further comprises one or more target arrays configured to collect at least some beams passing through at least one component of the apparatus.

In some embodiments, the one or more beam array sources are at least one of: one or more photonic integrated circuits (PICs); or one or more fiber arrays.

In some embodiments, the one or more beam-specific optics are at least one of: one or more metasurfaces; one or more diffractive optical elements (DOEs); one or more microlens arrays; one or more wire-grid polarizers; or one or more mode converters.

In some embodiments, the one or more global optics are at least one of: one or more conventional reflective optics; one or more conventional refractive optics; one or more conventional waveplates; or one or more conventional polarizers.

In some embodiments, the axial alignment configuration is achieved by physical geometry of the elements or manufactured housings.

In some embodiments, the radial alignment configuration is achieved by active optical alignment or aligned die bonding of the elements.

In some embodiments, the axial alignment defines pitch or yaw of the elements.

In some embodiments, the radial alignment defines roll of the elements.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view and an exploded view of a composite optical bench, according to an example embodiment;

FIG. 2 is a cross-sectional view of the composite optical bench of FIG. 1, according to an example embodiment;

FIGS. 3A, 3B, and 3C are top-down views of steps for fabricating wafer-fabricated optics, according to an example embodiment;

FIGS. 4A, 4B, 4C, 4D, and 4E are top-down views of steps for fabricating refractive optics, according to an example embodiment;

FIGS. 5A, 5B, 5C, 5D, 5E, and 5F are top-down views of steps for fabricating planar optics, according to an example embodiment;

FIG. 6 is a flow chart of an example method for fabricating a composite optical bench, according to an example embodiment;

FIG. 7 is a schematic diagram of an example quantum computing system comprising a three-level structure, according to an example embodiment;

FIG. 8 is a schematic diagram of an example controller of a quantum computer configured to perform one or more deterministic reshaping and/or reordering functions, according to various embodiments; and

FIG. 9 is a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

As used herein, the term “plate” may refer to a wafer, a substrate, and/or the like.

Some optical benches are comprised of a plurality of separately manufactured components. Such optical benches may, in some examples, rely on high accuracy mounting. For example, adjustable mounting and/or active control may be used to couple the plurality of separately manufactured components. Such optical benches having separately manufactured components may present challenges in usability, reliability, stability, and/or other factors.

In various embodiments, a die-and/or wafer-packaging approach may be relied upon to fabricate (and/or manufacture) multi-component optical modules, such as composite optical benches. Optical components, for example, such as photonic integrated circuits (PICs), diffractive optical elements (DOEs), metasurfaces, and/or the like may be separately fabricated and then aligned, mounted, and packaged into mechanically robust composite optical benches.

In various embodiments, microelectromechanical systems (MEMS) and/or optoelectronic die alignment and/or bonding capabilities may be used to couple (e.g., permanently couple) the separately fabricated optical components. In various embodiments, precision-fabricated spacers may be relied upon to define axial alignment, pitch, yaw, and/or the like to a high degree of accuracy (e.g., with error on the order of less than 1 μm). In various embodiments, die bonding may be relied upon to define lateral alignment, rolling, clocking, and/or the like to a high degree of accuracy (e.g., with error on the order of less than 300 nm, μrad).

In various embodiments, one or more pick-and-place techniques may be used to fabricate composite optical benches. For example, to carefully align and/or package the various optical components, at least one of the following techniques may be relied upon: (i) active and/or registered alignment in lateral dimensions (e.g., X-axis, Y-axis, rolling, clocking, and/or the like); and/or (ii) active and/or implicit alignment along a beam axis (e.g., Z-axis, pitch, yaw, and/or the like).

In various embodiments, fabricating a composite optical bench may comprise various steps and/or operations. For example, a method for fabricating a composite optical bench may include at least one of the following:
a. fabricating respective optical planes (e.g., fabricating metasurfaces, DOEs, microlenses, and/or the like on a plate; mounting conventional optics into a handle; mounting PICs into a handle, etc.); and/or
b. assembling the composite optical bench by aligning and/or bonding the respective optical planes, for example:
   i. for lateral alignment, using fabricated fiducials, active optical alignment, and/or other means of verifying alignment prior to bonding; and/or
   ii. for axial alignment, using uniformity and/or depth of optical plane substrates such as plates for fabricated optics and/or mounted handles for mounted conventional optics to verify alignment (e.g., optical plane substrate thickness may define the distance between optical planes, and uniformity thereof may indicate pitch and/or yaw).

In various embodiments, fabricated optics may be patterned and/or etched directly onto conventional optics, for example, onto a side of the conventional optic (e.g., onto the “front” side and/or the “back” side) such that the conventional optic is configured to act as a spacing element. In various embodiments, fabricated optics may be patterned and/or etched on a side of a plate (e.g., onto a first side such as a “front” side and/or a second side such as a “back” side). Spacing elements may be comprised of transparent and/or substantially transparent materials (e.g., glass) and or of material defining a cavity (e.g., hollow ring of glass, metal, and/or other materials).

In various embodiments, fiducials may include patterned marks visible by eye and/or through a microscope. A fiducial may be an optical feature configured to produce a signature responsive to incident light (e.g., such as a signature optical effect arising due to alignment and/or misalignment with a similar optical feature on a different substrate). A fiducial may be a physical aligner such as a plate flat and/or a notch and/or protrusion configured to enable mechanical registration (e.g., such a simple aligner comprised of one or more plate flats and/or notches; and/or such as a complex aligner comprised of one or more nested components configured to mechanically fit into one or more cavities defined by the one or more other nested components).

Thus, various embodiments provide technical improvements to the fields of optical benches and systems that include optical benches and/or other optical modules that may be replaced with optical benches.

### Exemplary Composite Optical Bench

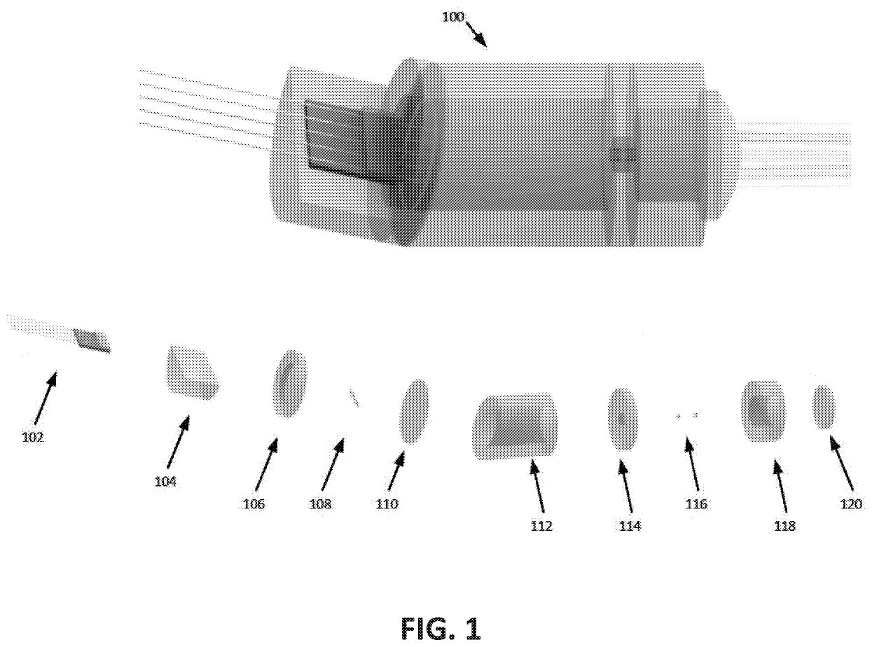

Referring now to FIG. 1, a perspective view and an exploded view of a composite optical bench 100 are provided. In the example of FIG. 1, the composite optical bench 100 is comprised of one or more glass spacer rings coupled to other components, for example, via glass-glass bonding and/or other types of bonding. The exploded view of the composite optical bench 100 includes: a fiber array 102, a housing 104 for the fiber array 102, a spacer ring 106, an optical component 108, a housing 110 for the optical component 108, a spacer ring 112, a spacer ring 114, an optical component 116, a spacer ring 118, and an optical component 120. Although the example of FIG. 1 shows one fiber array 102, one housing 104 for the fiber array 102, one spacer ring 106, one optical component 108, one housing 110 for the optical component 108, one spacer ring 112, one spacer ring 114, one optical component 116, one spacer ring 118, and one optical component 120, this is intended to be illustrative only and not limiting. For example, there may be any number of the various elements 102-120 in the composite optical bench 100. Similarly, any number of other components, instead of or in addition to, any one of the elements 102-120 may be included in the composite optical bench 100.

In some embodiments, the fiber array 102 may be comprised of one or more fiber arrays. In some embodiments, the fiber array 102 may be comprised of one or more fiber arrays and one or more PICs. In some embodiments, the housing 104 is configured to house the fiber array 102 and further configured to couple the fiber array 102 to the spacer ring 106. In some embodiments, the spacer ring 106 is configured to space the fiber array 102 and the optical component 108. In some embodiments, the optical component 108 includes one or more micro-optics. In some embodiments, the housing 110 for the optical component 108 is configured to house the optical component 108. The housing 110 may include a substrate configured to couple to the optical component 108. The housing 110 may be configured to act as a spacer such that it spaces the optical component 108 and the spacer 112.

In some embodiments, the spacer 112 is configured to couple to one or more portions of the composite optical bench 100 that have optical axes different than the optical axis of the spacer 112. For example, the optical component 108 may deflect one or more beams from a first optical axis to a second optical axis via the spacer 112. The first optical axis and the second optical axis are different optical axes. The first optical axis corresponds to a first portion of the composite optical bench 100 and the second optical axis corresponds to a second portion of the composite optical bench 100.

In some embodiments, the spacer ring 114 is configured to space the spacer 112 and the optical component 116. In some embodiments, the optical component 116 includes one or more optical components. In some embodiments, the optical component 116 is coupled to a housing and/or a substrate (the housing/substrate is not shown in FIG. 1, but it should be understood that the housing/substrate is configured to house the optical component 116, similar to other housings and/or substrates described herein). In some embodiments, the spacer ring 118 is configured to space the optical component 116 and the optical component 120.

Various embodiments of the present disclosure provide composite optical benches including a plurality of separately manufactured components which are mounded with a high degree of accuracy. In some embodiments, highly accurate and/or precise mounting is achieved via adjustable mounting and/or active control. In some embodiments, a die-and/or wafer-packaging approach is used in manufacturing optical modules having one or more components. In some embodiments, one or more optical components (e.g., conventional optics, photonic optics, and/or the like) such as PICs, DOEs, metasurfaces, and/or the like may be separately fabricated and then aligned, mounted, and packaged into a single optical module. For example, various MEMS and/or optoelectronic die alignment and/or bonding techniques may be used in the fabrication, alignment, and/or assembly of the optical module. In some embodiments, spacers (e.g., precision-fabricated spacers) may be used to define axial alignment, pitch, yaw, and/or the like. In some embodiments, die bonding may be used to define lateral and/or radial alignment. In some embodiments, die bonding may be used to define roll, clocking, and/or the like.

Various embodiments of the present disclosure provide miniaturized optical systems, for example, such as the composite optical benches described herein. In some embodiments, such miniaturized optical systems rely on precise (e.g., careful) alignment and/or packaging. For example, precise alignment may include active and/or registered alignment in lateral dimensions (e.g., x-and/or y-dimensions) to align the roll and/or clocking. Moreover, precise alignment may include active and/or baked-in alignment along a beam axis or one or more beam axes to align the pitch and/or yaw. In some embodiments, various pick-and-place techniques may be used in building, packaging, fabricating, and/or the like of optical systems, in particular, miniaturized optical systems.

Various embodiments of the present disclosure provide methods for building, packaging, fabricating, manufacturing, and/or the like of such miniaturized optical systems and/or their components. In some embodiments, one or more optical planes may be manufactured. For example, manufacturing the one or more optical planes may include at least: forming one or more metasurfaces, DOEs, microlenses, and/or the like on a substrate (e.g., a wafer); mounting one or more conventional optics onto a substrate (e.g., a handle); and/or mounting one or more PICs onto a substrate (e.g., a handle). In some embodiments, the one or more optical planes and/or one or more other components may be aligned and/or coupled to one another to assemble an optical system.

In some embodiments, lateral alignment may be variously achieved. For example, lateral alignment may be achieved using fiducials on one or more components. For example, lateral alignment may be achieved using active optical alignment. For example, lateral alignment may be achieved using one or more other techniques.

In some embodiments, axial alignment may be variously achieved. For example, axial alignment may be achieved based on uniformity and/or depth of various optical plane substrates. In some embodiments, wafers, handles, and/or other components may act as optical plane substrates. In some embodiments, the thickness of an optical plane substrate may dictate the distance between two or more optical planes; the uniformity of that thickness may dictate the pitch and/or yaw.

In some embodiments, fabricated optics may be patterned directly on conventional optics. For example, fabricated optics may be patterned on a front side of a conventional optic, on a back side of the conventional optic, or on both the front and the back sides of the conventional optic. If the fabricated optics are patterned on both the front side and the back side of the conventional optic, the conventional optic itself may act as a spacer configured to space the fabricated optics.

In some embodiments, fabricated optics may be patterned on a front side of a wafer, on a back side of the wafer, or on both the front and the back sides of the wafer. In some embodiments, transparent materials may be used as spacers (e.g., glass and/or other transparent or substantially transparent materials). In some embodiments, a component defining a cavity may act as a spacer (e.g., a ring and/or the like) such that the region of the cavity is the spacer.

In some embodiments, fiducials may include patterned marks that are visible by eye and/or through a microscope. In some embodiments, fiducials may be optical features which produce a signature based on light being incident to the fiducials. For example, such a signature may be a signature optical effect arising from alignment and/or misalignment of the fiducials with one or more other similar features. In some embodiments, fiducials may be physical aligners (e.g., a flat wafer, a wafer with notches, a wafer with protrusions, and/or the like) which enable mechanical registration. For example, physical aligners may include two or more nested components which are configured to fit each other's features (e.g., a first component defining a cavity and a second component defining a protrusion which fits into the cavity, for example, like a puzzle piece).

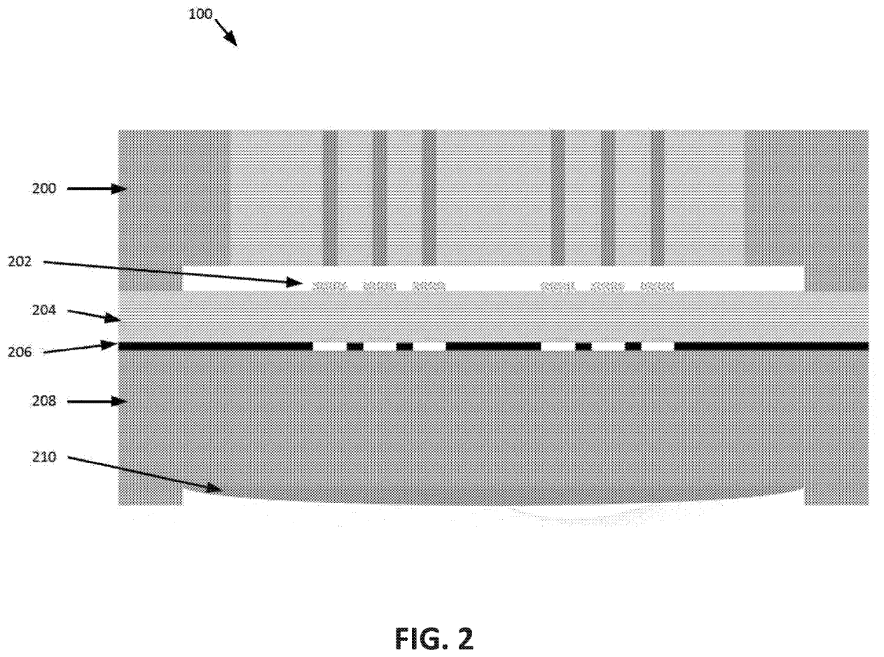

Referring now to FIG. 2, a cross-sectional view of the composite optical bench 100 of FIG. 1 is provided. The cross-sectional view shown in the example of FIG. 2 illustrates axial alignment of the various components of the composite optical bench 100. The example of FIG. 2 includes an assembly 200, one or more wafer-fabricated optics 202, one or more plates 204, a filter layer 206, a second spacing element 208 defining an inset cavity, and a convex lens 210 disposed within the inset cavity. The convex lens 210 acts as a global optic in this illustrated embodiment, wherein a global optic is configured to interact with and/or at least partially define respective portions of a plurality of optical channels/paths.

The assembly 200 may comprise a PIC mounted on a first spacing element. The first spacing element may be comprised of transparent and/or substantially transparent material(s), for example, such as glass. The PIC may be configured to couple the composite optical bench 100 to one or more other devices, for example, such as an atomic object confinement apparatus. The assembly 200 may define a first inset cavity configured to space the PIC and the one or more wafer-fabricated optics 202.

The one or more wafer-fabricated optics 202 may comprise metasurfaces, DOEs, microlens arrays, and/or other fabricated optics. The one or more wafer-fabricated optics 202 may be defined (e.g., patterned, etched, and/or the like) onto at least one side of a plate. In the example of FIG. 2, the one or more wafer-fabricated optics 202 are defined on a side of the plate proximate to the assembly 200.

The one or more plates 204 may be comprised of various types of wafers, substrates, and/or other components. In various embodiments, the one or more plates 204 may be comprised of transparent and/or substantially transparent material(s). The one or more plates 204 may be configured to define spacing between one or more components of the optical bench 100, for example, such as spacing between the one or more wafer-fabricated optics 202 and the filter layer 206.

The filter layer 206 may be comprised of a pinhole filter and/or other types of filters. The filter layer may be comprised of a plate defining one or more cavities configured to act as pinholes, such that they filter out at least a portion of incident electromagnetic radiation (e.g., incident light).

The second spacing element 208 may be a spacing element comprised of transparent and/or substantially transparent material(s). In various embodiments, the second spacing element 208 is disposed proximate to the filter layer 206. The second spacing element 208 may define a second inset cavity configured to comprise the convex lens 210.

The convex lens 210 may be a conventional optic and/or a non-conventional optic. In various embodiments, the convex lens 210 may be comprised of glass and/or other transparent or substantially transparent materials. The convex lens 210 may be disposed within the second inset cavity defined by the second spacing element 208.

### Exemplary Wafer-fabricated Optics

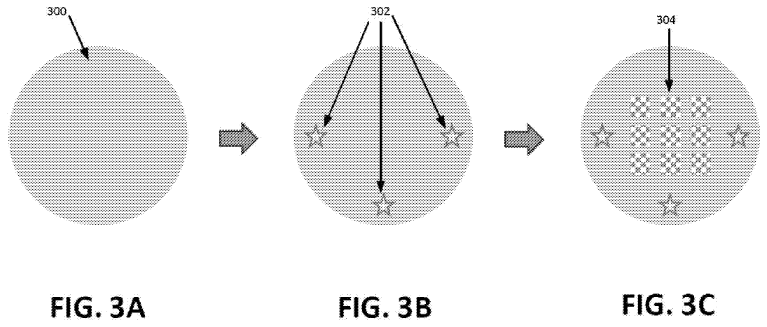

FIGS. 3A, 3B, and 3C provide respective top-down views of steps for fabricating wafer-fabricated optics (e.g., such as the wafer-fabricated optics 202). At the step/operation shown in FIG. 3A, a plate 300 may be obtained. The plate 300 may be comprised of transparent and/or substantially transparent material(s). At the step/operation shown in FIG. 3B, one or more alignment markings 302 may be disposed and/or formed on a second plate. For example, one or more front alignment markings may be disposed and/or formed on a first side of the second plate, and/or one or more back alignment markings may be disposed and/or formed on a second side of the second plate. In various embodiments, the first side of the second plate is opposite the second side of the second plate. At the step/operation shown in FIG. 3C, the one or more wafer-fabricated optics may be defined in one or more respective regions 304 of the second plate. For example, the one or more regions may be predetermined.

### Exemplary Refractive Optics

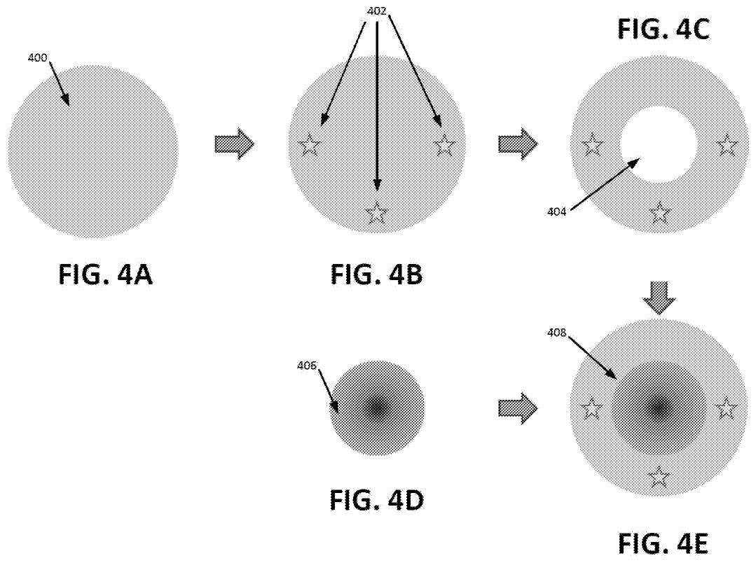

FIGS. 4A, 4B, 4C, 4D, and 4E provide top-down views of steps for fabricating refractive optics (e.g., such as the second spacing element 208 and/or the convex lens 210). At the step/operation shown in FIG. 4A, a substantially cylindrical element 400 may be obtained. In various embodiments, the substantially cylindrical element may be comprised of transparent and/or substantially transparent material(s). At the step/operation shown in FIG. 4B, one or more alignment markings 402 may be disposed and/or formed on a third plate. For example, one or more front alignment markings may be disposed and/or formed on a first side of the third plate, and/or one or more back alignment markings may be disposed and/or formed on a second side of the third plate. In various embodiments, the first side of the third plate is opposite the second side of the third plate. At the step/operation shown in FIG. 4C, a substantially cylindrical cavity 404 may be defined at approximately a center of the third plate. At the step/operation shown in FIG. 4D, a convex lens 406 (e.g., the convex lens 210) may be fabricated. At the step/operation shown in FIG. 4E, the convex lens 406 may be mounted 408 such that its substantially flat side is proximate to the third plate. In various embodiments, the steps/operations shown in FIGS. 4D and 4E, respectively, may be performed in succession, contemporaneously, otherwise in combination, and/or alternatively of one another.

### Exemplary Planar Optics

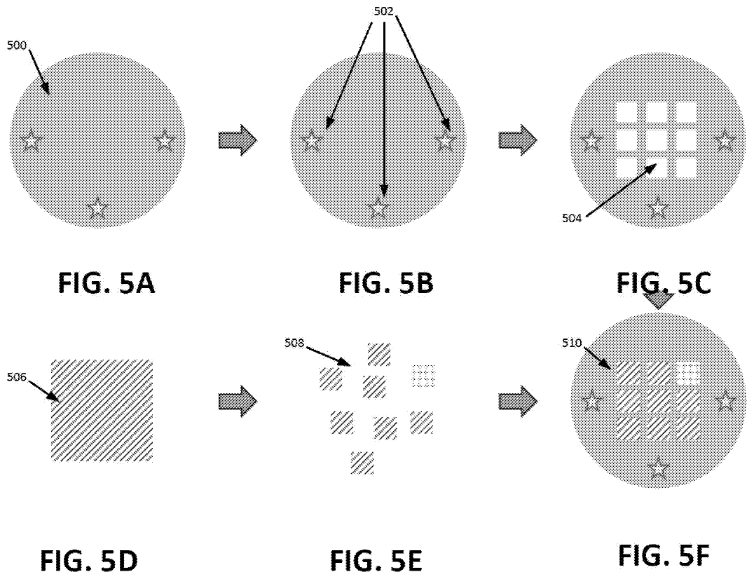

FIGS. 5A, 5B, 5C, 5D, 5E, and 5F provide top-down views of steps for fabricating planar optics (e.g., such as the filter layer 206, pinhole filters, waveplates, and/or the like). At the step/operation shown in FIG. 5A, a substantially cylindrical element 500 may be obtained. In various embodiments, the substantially cylindrical element may be comprised of transparent and/or substantially transparent material(s). At the step/operation shown in FIG. 5B, one or more alignment markings 502 may be disposed and/or formed on a first plate. For example, one or more front alignment markings may be disposed and/or formed on a first side of the first plate; and/or one or more back alignment markings may be disposed and/or formed on a second side of the first plate. At the step/operation shown in FIG. 5C, one or more cavities 504 may be defined in the first plate. In various embodiments, the one or more cavities 504 may be defined by etching, patterning, and/or other techniques. At the step/operation shown in FIG. 5D, one or more planar optical elements 506 may be fabricated. At the step/operation shown in FIG. 5E, respective planar optical elements of the one or more optical elements may be divided into one or more smaller planar optical elements of one or more predetermined sizes and/or one or more predetermined shapes. At the step/operation shown in FIG. 5F, the one or more smaller planar optical elements may be die bonded 510 on the first plate at one or more locations corresponding to the one or more cavities 504 defined in the first plate.

### Exemplary Methods for Fabricating a Composite Optical Bench

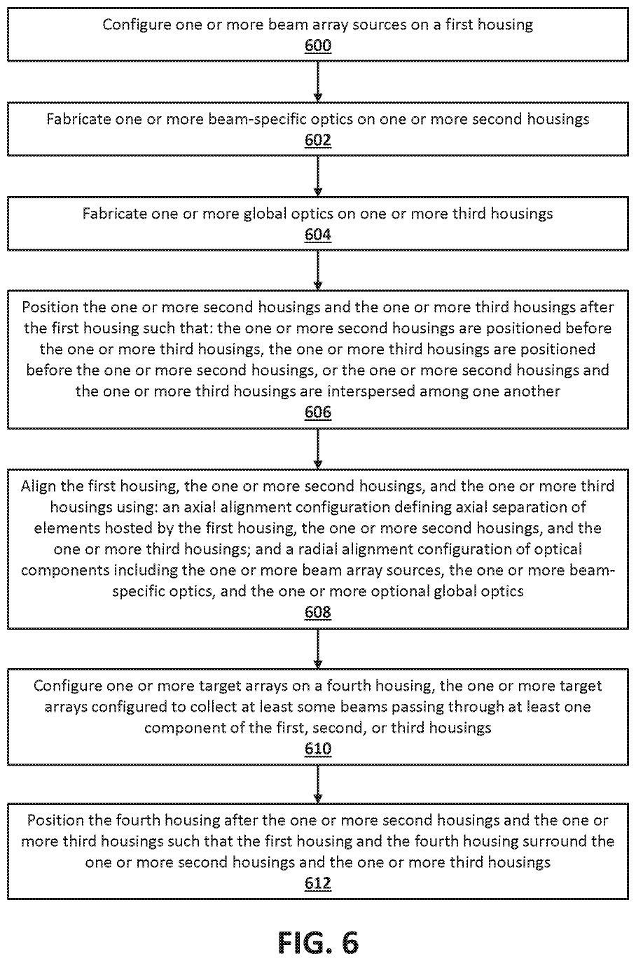

FIG. 6 is a flow chart describing an example method for fabricating a composite optical bench.

At step/operation 600, one or more beam array sources may be configured on a first housing.

At step/operation 602, one or more beam-specific optics may be fabricated on one or more second housings.

At step/operation 604, one or more global optics may be fabricated on one or more third housings. In some embodiments, the one or more global optics are optional such that they are partially or fully omitted.

At step/operation 606, the one or more second housings and the one or more third housings may be positioned after the first housing such that: the one or more second housings are positioned before the one or more third housings, the one or more third housings are positioned before the one or more second housings, or the one or more second housings and the one or more third housings are interspersed among one another.

At step/operation 608, the first housing, the one or more second housings, and the one or more third housings may be aligned using: an axial alignment configuration defining axial separation of elements hosted by the first housing, the one or more second housings, and the one or more third housings; and a radial alignment configuration of optical components including the one or more beam array sources, the one or more beam-specific optics, and the one or more optional global optics.

At step/operation 610, one or more target arrays may be configured on a fourth housing. In some embodiments, the one or more target arrays may be configured to collect at least some beams passing through at least one component of the first, second, or third housings.

At step/operation 612, the fourth housing may be positioned after the one or more second housings and the one or more third housings such that the first housing and the fourth housing surround the one or more second housings and the one or more third housings.

### Technical Advantages

Various embodiments provide technical advantages, as described herein. In various embodiments, composite (e.g., permanent) packaging of components of the composite optical benches may decrease overall footprint of the optical benches and/or simply use thereof. For example, relying on die-and/or wafer-packaging approaches to manufacture multi-component optical modules may result in smaller, more mechanically robust optical modules than those manufactured via other techniques. Other advantages may include improved usability, reliability, and/or stability under various conditions.

### Example Quantum Computing System Comprising a Confinement Apparatus

Various embodiments provide composite optical benches. Various embodiments provide systems that include one or more of such composite optical benches. Various embodiments provide various optical, electro-optical, opto-mechanical systems that include such composite optical benches. One example system is a quantum computing system.

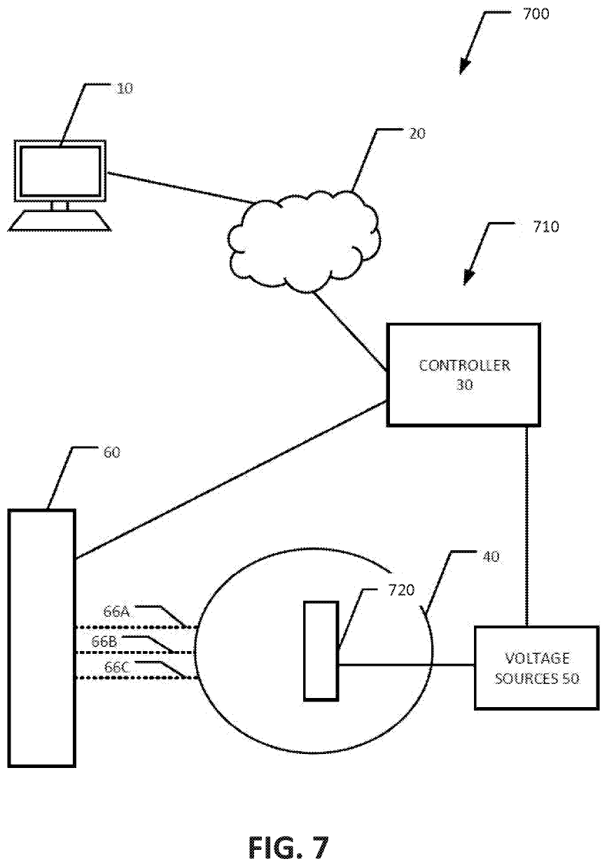

FIG. 7 provides a schematic diagram of an example quantum computing system 700 comprising an atomic object confinement apparatus 720 (e.g., an ion trap such as a surface ion trap, Paul trap, and/or the like), which is also referred to as a confinement apparatus herein, in accordance with an example embodiment. In various embodiments, the atomic object confinement apparatus 720 is configured to confine one or more atomic objects (e.g., neutral or ionic atoms; neutral, ionic, or multipolar molecules; and/or the like). For example, FIG. 7 schematically illustrates an example quantum charge-coupled device (QCCD)-based quantum computer. However, various high density optical interconnects may be incorporated into various types of quantum computers (e.g., for providing manipulation signals for qubit interaction, cooling, and/or the like) and/or various types of atomic systems (e.g., for providing manipulation signals for trapped particle/ion/atom/molecule interaction).

In various embodiments, the quantum computing system 700 comprises a computing entity 10 and a quantum computer 710. In various embodiments, the quantum computer 710 comprises a controller 30, a cryostat and/or vacuum chamber 40 enclosing a confinement apparatus 720 (e.g., an ion trap), and one or more manipulation sources 60. For example, the cryostat and/or vacuum chamber 40 may be a pressure-controlled chamber. In an example embodiment, the manipulation signals generated by the manipulation sources 60 are provided to the interior of the cryostat and/or vacuum chamber 40 (where the atomic object confinement apparatus 720 is located) via corresponding optical paths 66 (e.g., 66A, 66B, 66C). In an example embodiment, the one or more manipulation sources 60 may comprise one or more lasers (e.g., optical lasers, microwave sources, and/or the like). In various embodiments, each manipulation source is configured to generate a manipulation signal having a respective characteristic wavelength in the microwave, infrared, visible, or ultraviolet portion of the electromagnetic spectrum. In various embodiments, the one or more manipulation sources 60 are configured to manipulate and/or cause a controlled quantum state evolution of one or more atomic objects within the confinement apparatus. For example, in an example embodiment, wherein the one or more manipulation sources 60 comprise one or more lasers, the lasers may provide one or more laser beams to atomic objects trapped within the confinement apparatus 720 within the cryostat and/or vacuum chamber 40. For example, the manipulation sources 60 may be configured to generate one or more beams that may be used to initialize an atomic object into a state of a qubit space such that the atomic object may be used as a qubit of the confined atomic object quantum computer, perform one or more gates on one or more qubits of the confined atomic object quantum computer, read and/or determine a state of one or more qubits of the confined atomic object quantum computer, and/or the like.

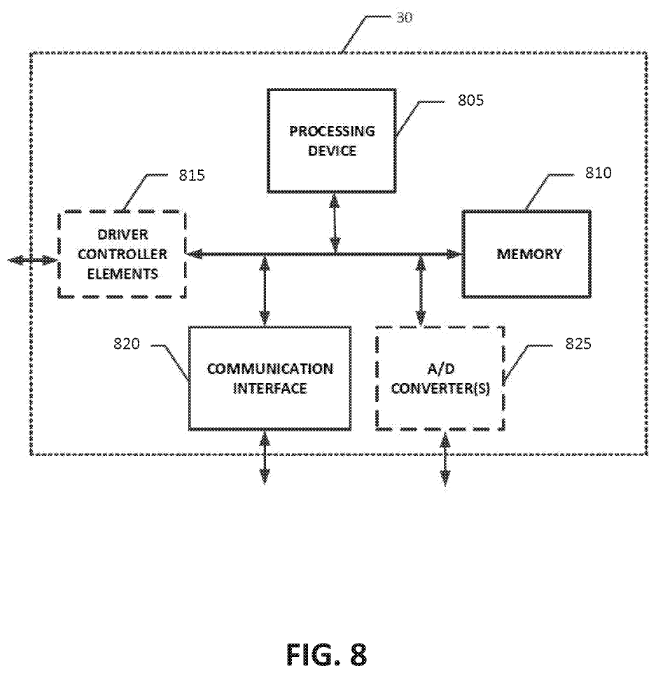

In various embodiments, the quantum computer 710 comprises an optics collection system configured to collect and/or detect photons generated by qubits (e.g., during reading procedures). The optics collection system may comprise one or more optical elements (e.g., three-level structures, lenses, mirrors, waveguides, fiber optics cables, and/or the like) and one or more photodetectors. In various embodiments, the optical elements include diffractive optical elements such as grating couplers. In various embodiments, grating couplers may be comprised of one or more three-level structures. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum computer. In various embodiments, the detectors may be in electronic communication with the controller 30 via one or more A/D converters 825 (see FIG. 8) and/or the like. For example, an atomic object being read and/or having its quantum state determined may emit an emitted signal, at least a portion of which is incident on a collection array of meta material structures formed and/or disposed on the surface of the atomic object confinement apparatus 720. The emitted signal being incident on the collection array of meta material structures induces the meta material structures to emit a detected signal directed toward and/or focused at collection optics of the atomic object confinement apparatus. The collection optics are configured to provide the collection signal to a photodetector.

In various embodiments, the quantum computer 710 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 720, in an example embodiment.

In various embodiments, a computing entity 10 is configured to allow a user to provide input to the quantum computer 710 (e.g., via a user interface of the computing entity 10) and receive, view, and/or the like output from the quantum computer 710. The computing entity 10 may be in communication with the controller 30 of the quantum computer 710 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, and/or the like) within the cryostat and/or vacuum chamber 40 and/or configured to manipulate and/or cause a controlled evolution of quantum states of one or more atomic objects within the confinement apparatus. For example, the controller 30 may cause a controlled evolution of quantum states of one or more atomic objects within the confinement apparatus to execute a quantum circuit and/or algorithm. For example, the controller 30 may cause a reading procedure comprising coherent shelving to be performed, possibly as part of executing a quantum circuit and/or algorithm. In various embodiments, the atomic objects confined within the confinement apparatus are used as qubits of the quantum computer 710.

### Example Controller

In various embodiments, a confinement apparatus 720 is incorporated into a system (e.g., a quantum computer 710) comprising a controller 30. In various embodiments, the controller 30 is configured to control various elements of the system (e.g., quantum computer 710). For example, the controller 30 may be configured to control the voltage sources 50, a cryostat system and/or vacuum system controlling the temperature and pressure within the cryostat and/or vacuum chamber 40, manipulation sources 60, cooling system, and/or other systems controlling the environmental conditions (e.g., temperature, humidity, pressure, and/or the like) within the cryostat and/or vacuum chamber 40 and/or configured to manipulate and/or cause a controlled evolution of quantum states of one or more atomic objects confined by the atomic object confinement apparatus 720. In various embodiments, the controller 30 may be configured to receive signals from one or more optics collection systems.

As shown in FIG. 8, in various embodiments, the controller 30 may comprise various controller elements including processing elements 805, memory 810, driver controller elements 815, a communication interface 820, analog-digital converter elements 825, and/or the like. For example, the processing elements 805 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 805 of the controller 30 comprises a clock and/or is in communication with a clock.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 810 (e.g., by a processing element 805) causes the controller 30 to perform one or more steps, operations, processes, procedures and/or the like described herein for providing manipulation signals to atomic object locations and/or collecting, detecting, capturing, and/or measuring indications of emitted signals emitted by atomic objects located at corresponding atomic object locations of the atomic object confinement apparatus 720.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 805). In various embodiments, the driver controller elements 815 may enable the controller 30 to operate a voltage sources 50, manipulation sources 60, cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping potential of the atomic object confinement apparatus 720 (and/or other drivers for providing driver action sequences to potential generating elements of the atomic object confinement apparatus); cryostat and/or vacuum system component drivers; cooling system drivers, and/or the like. In various embodiments, the controller 30 comprises means for communicating and/or receiving signals from one or more optical receiver components (e.g., photodetectors of the optics collection system). For example, the controller 30 may comprise one or more analog-digital converter elements 825 configured to receive signals from one or more optical receiver components (e.g., a photodetector of the optics collection system), calibration sensors, and/or the like.

In various embodiments, the controller 30 may comprise a communication interface 820 for interfacing and/or communicating with a computing entity 10. For example, the controller 30 may comprise a communication interface 820 for receiving executable instructions, command sets, and/or the like from the computing entity 10 and providing output received from the quantum computer 710 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Example Computing Entity

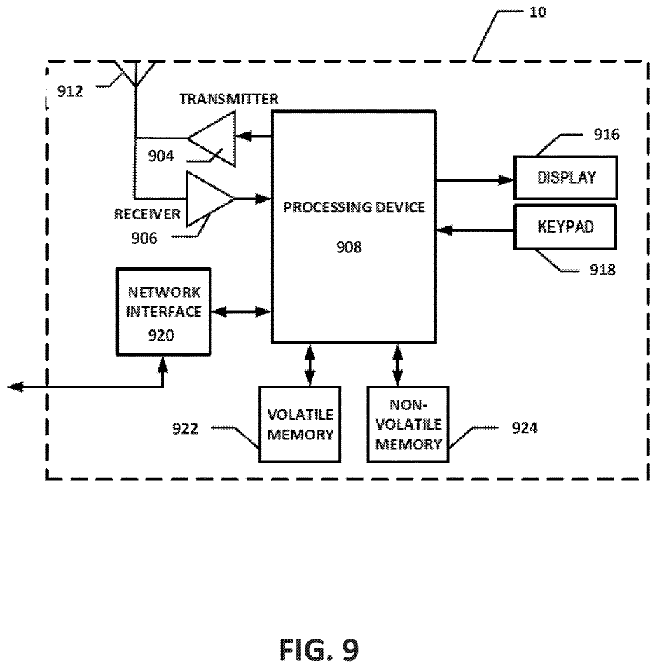

FIG. 9 provides an illustrative schematic representative of an example computing entity 10 that can be used in conjunction with embodiments of the present invention. In various embodiments, the computing entity 10 is a classical or semiconductor-based computing apparatus that is part of the quantum computing system 700.

In various embodiments, the computing entity 10 is configured to allow a user to provide input to the quantum computer 710 (e.g., via a user interface of the computing entity 10) and receive, display, analyze, and/or the like output from the quantum computer 710.

As shown in FIG. 9, a computing entity 10 can include an antenna 912, a transmitter 904 (e.g., radio), a receiver 906 (e.g., radio), and a processing element 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 comprises one or more network interfaces 920 configured for communicating via one or more wired and/or wireless computer networks.

The computing entity 10 may also comprise a user interface device comprising one or more user input/output interfaces (e.g., a display 916 and/or speaker/speaker driver coupled to a processing element 908 and a touch screen, keyboard, mouse, and/or microphone coupled to a processing element 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. That which is claimed:

1. An apparatus comprising:
one or more beam array sources hosted by a first housing;
one or more beam-specific optics hosted by one or more second housings; and
one or more optional global optics hosted by one or more third housings,
wherein the first housing, the one or more second housings, and the one or more third housings are aligned using:
an axial alignment configuration defining axial separation of elements hosted by the first housing, the one or more second housings, and the one or more third housings; and
a radial alignment configuration of optical components including the one or more beam array sources, the one or more beam-specific optics, and the one or more optional global optics, and
wherein the one or more second housings and the one or more third housings are positioned after the first housing, and wherein the one or more second housings and the one or more third housings are variously positioned.

2. The apparatus of claim 1, wherein:
the one or more second housings are positioned before the one or more third housings;
the one or more third housings are positioned before the one or more second housings; or
the one or more second housings and the one or more third housings are interspersed among one another.

3. The apparatus of claim 1, further comprising:
one or more target arrays configured to collect at least some beams passing through at least one component of the apparatus.

4. The apparatus of claim 1, wherein the one or more beam array sources are at least one of:
one or more photonic integrated circuits (PICs); or
one or more fiber arrays.

5. The apparatus of claim 1, wherein the one or more beam-specific optics are at least one of:
one or more metasurfaces;
one or more diffractive optical elements (DOEs);
one or more microlens arrays;
one or more wire-grid polarizers; or
one or more mode converters.

6. The apparatus of claim 1, wherein the one or more global optics are at least one of:
one or more conventional reflective optics;
one or more conventional refractive optics;
one or more conventional waveplates; or
one or more conventional polarizers.

7. The apparatus of claim 1, wherein the axial alignment configuration is achieved by physical geometry of the elements or manufactured housings.

8. The apparatus of claim 1, wherein the radial alignment configuration is achieved by active optical alignment or aligned die bonding of the elements.

9. The apparatus of claim 7, wherein the axial alignment defines pitch or yaw of the elements.

10. The apparatus of claim 8, wherein the radial alignment defines roll of the elements.

11. A method comprising:
configuring one or more beam array sources on a first housing;
fabricating one or more beam-specific optics on one or more second housings;
fabricating one or more optional global optics on one or more third housings;
positioning the one or more second housings and the one or more third housings after the first housing; and
aligning the first housing, the one or more second housings, and the one or more third housings using:
an axial alignment configuration defining axial separation of elements hosted by the first housing, the one or more second housings, and the one or more third housings; and
a radial alignment configuration of optical components including the one or more beam array sources, the one or more beam-specific optics, and the one or more optional global optics.

12. The method of claim 11, further comprising variously positioning the one or more second housings and the one or more third housings such that:
the one or more second housings are positioned before the one or more third housings;
the one or more third housings are positioned before the one or more second housings; or
the one or more second housings and the one or more third housings are interspersed among one another.

13. The method of claim 11, further comprising:
configuring one or more target arrays on a fourth housing, the one or more target arrays configured to collect at least some beams passing through at least one component of the first, second, or third housings; and
positioning the fourth housing after the variously positioned one or more second housings and one or more third housings such that the first housing and the fourth housing surround the one or more second housings and the one or more third housings.

14. The method of claim 11, wherein the axial alignment configuration is achieved by physical geometry of the elements or manufactured housings.

15. The method of claim 11, wherein the radial alignment configuration is achieved by active optical alignment or aligned die bonding of the elements.

16. The method of claim 15, wherein the axial alignment defines pitch or yaw of the elements.

17. The method of claim 15, wherein the radial alignment defines roll of the elements.

18. A system comprising:
an atomic particle confinement apparatus; and
a composite optical bench assembly comprising:
one or more beam array sources hosted by a first housing;
one or more beam-specific optics hosted by one or more second housings; and
one or more optional global optics hosted by one or more third housings,
wherein the first housing, the one or more second housings, and the one or more third housings are aligned using:
an axial alignment configuration defining axial separation of elements hosted by the first housing, the one or more second housings, and the one or more third housings; and
a radial alignment configuration of optical components including the one or more beam array sources, the one or more beam-specific optics, and the one or more optional global optics, and
wherein the one or more second housings and the one or more third housings are positioned after the first housing, and wherein the one or more second housings and the one or more third housings are variously positioned.

19. The system of claim 18, wherein:
the one or more second housings are positioned before the one or more third housings;
the one or more third housings are positioned before the one or more second housings; or
the one or more second housings and the one or more third housings are interspersed among one another.

20. The system of claim 18, further comprising:
one or more target arrays configured to collect at least some beams passing through at least one component of the apparatus.
